(19) United States
(12) Patent Application Publication
(10) Pub. No.: US 2022/0129173 A1
(43) Pub. Date: Apr. 28, 2022

(54) STORAGE ARRAY RESOURCE CONTROL

(71) Applicant: EMC IP Holding Company LLC, Hopkinton, MA (US)

(72) Inventors: Owen Martin, Hopedale, MA (US); Arieh Don, Newton, MA (US)

(73) Assignee: EMC IP Holding Company LLC, Hopkinton, MA (US)

(21) Appl. No.: 17/076,964

(22) Filed: Oct. 22, 2020

(51) Int. Cl. G06F 3/06; G06F 11/34

(52) U.S. Cl. CPC G06F 3/0631; G06F 3/067; G06F 11/3433; G06F 3/0655; G06F 3/0611

(57) ABSTRACT

Aspects of the present disclosure relate to controlling storage array resource consumption. In embodiments, a storage array performance metric can be measured at a host device side of one or more storage area networks (SANs). Further, a resource consumption of at least one component of the storage array can be controlled based on the performance metric.

### BACKGROUND

A storage array is a data storage system for block-based storage, file-based storage, or object storage. Rather than store data on a server, storage arrays use multiple drives in a collection capable of storing a vast amount of data. Storage arrays can include a central management system that manages the data. The storage arrays can receive high volumes of data access requests that can exceed their respective bandwidths for processing the data requests. Accordingly, storage arrays can include techniques for controlling resource consumption.

### SUMMARY

Aspects of the present disclosure relate to controlling storage array resource consumption. In embodiments, a storage array performance metric can be measured at a host device side of one or more storage area networks (SANs). Further, a resource consumption of at least one component of the storage array can be controlled based on the performance metric.

In embodiments, a service level objective (SLO) of each input/output (IO) operation received by a storage array can be determined. Further, all possible SLOs (Service Level Objectives) associated with each host organization authorized to communicate with the storage array can be determined.

In embodiments, storage groups associated with each of the SLOs can be identified.

In embodiments, each logical unit number (LUN) device associated with each storage group can be determined.

In embodiments, a communication port assigned to each LUN device can be identified.

In embodiments, a SAN of the one or more SANs over which each communication port is configured to issue communication signals can be determined.

In embodiments, a congestion level of each of the SANs can be determined.

In embodiments, an impact the congestion level of each SAN has on the performance metric can be determined.

In embodiments, a host side SAN load balancing protocol can be adapted to measure the storage array performance metric

In embodiments, whether a response time of a message sent to a host device over one of the SANs meets an SLO expected by the host device using measurements received from the adapted host side SAN load balancing protocol can be determined.

In embodiments, the storage group that is a source of the message can be determined. The SAN associated with the storage group can be identified. Messages corresponding to low priority SLOs that share the identified SAN can be throttled.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a block diagram of a storage system in accordance with example embodiments disclosed herein.

FIG. 2 is a block diagram of a performance measurement system in accordance with example embodiments disclosed herein.

FIG. 3 is a flow diagram of a method for storage group (SG) based resource control in accordance with example embodiments disclosed herein.

FIG. 4 is a flow diagram of a method for service level objective (SLO) based resource control in accordance with example embodiments disclosed herein.

### DETAILED DESCRIPTION

A storage array is a data storage system for block-based storage, file-based storage, or object storage. Rather than store data on a server, storage arrays use multiple drives in a collection capable of storing a vast amount of data. Storage arrays can include a central management system that manages the data. Storage arrays can receive high volumes of data access requests exceeding their respective data processing bandwidths. Accordingly, storage arrays can include techniques for controlling resource consumption.

The techniques can include policies that control resource consumption in a manner to ensure the storage array remains compliant with a host's service level agreement (SLA). The SLA defines a host's performance expectation of, e.g., the array's response times to IO requests (IOs). Current techniques only determine compliance based on response time measurements taken on an array side of a storage area network (SAN). For instance, a host can return a message having a time stamp in response to receiving a storage array reply to an IO request. If the time stamp indicates that the host received the reply at a time that is incompliant with the SLA, the array performs resource control techniques to limit resources allocated to low priority IO requests. However, these current techniques fail to consider SAN congestion as being a source of latency, which is unrelated to the array's performance. As such, the current techniques can unnecessarily limit resources to IO requests.

Accordingly, embodiments of the present disclosure can measure a storage array performance metric at a host device side of one or more storage area networks (SANs). Further, a resource consumption of at least one component of the storage array can be controlled based on the performance metric.

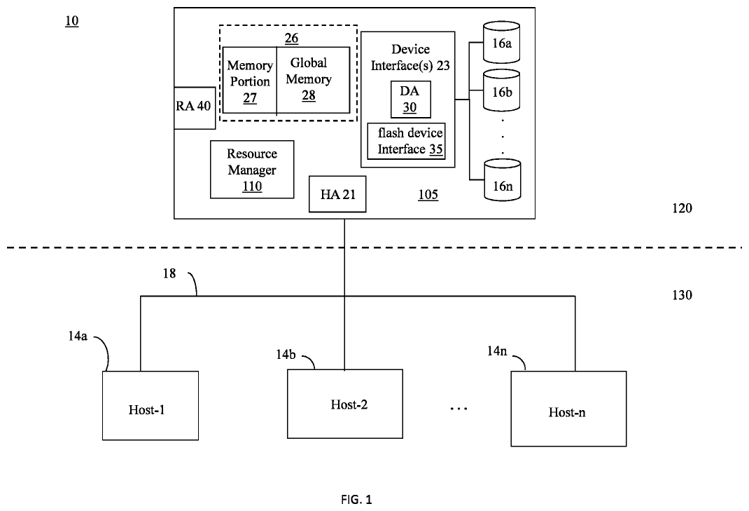

Referring to FIG. 1, a system 10 includes a data storage array 105 connected to host systems 14a-n through communication medium 18. In embodiments, the hosts 14a-n can access the data storage array 105, for example, to perform input/output (IO) operations or data requests. The communication medium 18 can be any one or more of a variety of networks or other type of communication connections as known to those skilled in the art. The communication medium 18 may be a network connection, bus, and/or other type of data link, such as a hardwire or other connections known in the art. For example, the communication medium 18 may be the Internet, an intranet, network (including a Storage Area Network (SAN)) or other wireless or other hardwired connection(s) by which the host 14a-n can access and communicate with the data storage array 105. The hosts 14a-n can also communicate with other components included in the system 10 via the communication medium 18.

Each of the hosts 14a-n and the data storage array 105 can be connected to the communication medium 18 by any one of a variety of connections as may be provided and supported in accordance with the type of communication medium 18. The processors included in the hosts 14a-n may be any one of a variety of proprietary or commercially available single or multi-processor system, such as an Intel-based processor, or other type of commercially available processor able to support traffic in accordance with each embodiment and application.

It should be noted that the examples of the hardware and software that may be included in the data storage array 105 are described herein in more detail and can vary with each embodiment. Each of the hosts 14a-n and data storage array 105 can all be located at the same physical site or can be in different physical locations. Examples of the communication medium 18 that can be used to provide the different types of connections between the host computer systems and the data storage array 105 of the system 10 can use a variety of different communication protocols such as SCSI (Small Computer Systems Interface), Fibre Channel, iSCSI, Non-Volatile Memory Express (NVMe), and the like. Some or all the connections by which the hosts 14a-n and data storage array 105 can be connected to the communication medium may pass through other communication devices, such switching equipment that may exist such as a phone line, a repeater, a multiplexer or even a satellite.

Each of the hosts 14a-n can perform different types of data operations in accordance with different types of tasks. In embodiments, any one of the hosts 14a-n may issue a data request to the data storage array 105 to perform a data operation. For example, an application executing on one of the hosts 14a-n can perform a read or write operation resulting in one or more data requests to the data storage array 105.

It should be noted that although array 105 is illustrated as a single data array, array 105 may also represent, for example, multiple data storage arrays alone, or in combination with, other data storage devices, systems, appliances, and/or components having suitable connectivity, such as in a SAN, in an embodiment using the embodiments herein. It should also be noted that an embodiment may include data storage arrays or other components from one or more vendors. In subsequent examples illustrated the embodiments herein, reference may be made to a single data storage array by a vendor, such as by DELL Technologies of Hopkinton, Mass. However, as will be appreciated by those skilled in the art, the embodiments herein are applicable for use with other data storage arrays by other vendors and with other components than as described herein for purposes of example.

The data storage array 105 can include a plurality of data storage devices 16a-n. The data storage devices 16a-n can include one or more types of data storage devices such as, for example, one or more disk drives and/or one or more solid state drives (SSDs). An SSD is a data storage device that uses solid-state memory to store persistent data. An SSD using SRAM (synchronous RAM (Random Access Memory)) or DRAM (dynamic RAM), rather than flash memory, may also be referred to as a RAM drive. SSD may refer to solid state electronics devices as distinguished from electromechanical devices, such as hard drives, having moving parts. Flash devices or flash memory-based SSDs are one type of SSD that has no moving parts. In embodiments, one or more of the devices 16a-n can include flash drives or devices. In further embodiments, the devices 16a-n can include at least one solid state drive (SSD).

The data storage array 105 may also include different types of adapters or directors, such as an HA 21 (host adapter), RA 40 (remote adapter), and/or device interface 23. Each of the adapters HA 21, RA 40 may be implemented using hardware including a processor with local memory with code stored thereon for execution in connection with performing different operations. The HA 21 may be used to manage communications and data operations between one or more host systems 14a-n and the global memory (GM) 28. In an embodiment, the HA 21 may be a Fibre Channel Adapter (FA) or another adapter which facilitates host communication. The HA 21 may be characterized as a front-end component of the data storage array 105 which receives a request from one or more of the hosts 14a-n. The data storage array 105 can include one or more RAs (Remote Adapters) (e.g., RA 40) that may be used, for example, to facilitate communications between data storage arrays. The data storage array 105 may also include one or more device interfaces 23 for facilitating data transfers to/from the data storage devices 16a-n. The data storage interfaces 23 may include device interface modules, for example, one or more disk adapters (DAs) 30 (e.g., disk controllers), flash drive interface 35, and the like. The DA 30 can be characterized as a back-end component of the data storage array 105 which interfaces with the physical data storage devices 16a-n.

One or more internal logical communication paths may exist between the device interfaces 23, the RAs 40, the HAs (Host Adapters) 21, and the memory 26. An embodiment, for example, may use one or more internal busses and/or communication modules. For example, the global memory 28 can be used to facilitate data transfers and other communications between the device interfaces, HAs and/or RAs in a data storage array. In one embodiment, the device interfaces 23 may perform data operations using a cache that may be included in the global memory 28, for example, when communicating with other device interfaces and other components of the data storage array. Memory portion 27 is a portion of memory 26 that may be used in connection with other designations that may vary in accordance with each embodiment.

The data storage array 105 as described in this embodiment, or a device thereof, such as a disk or aspects of a flash device, should not be construed as a limitation. Other types of commercially available data storage arrays, as well as processors and hardware controlling access to these devices, may also be included in an embodiment.

Host systems 14a-n provide data and access control information through channels (e.g., via communications medium 18) to the storage array 105, and the storage array 105 may also provide data to the host systems 14a-n also through the channels. In embodiments, the host systems 14a-n may not be configured to address the drives or devices 16a-n of the storage array 105 directly, but rather access to data can be provided to one or more host systems 14a-n from what the host systems view as a plurality of logical devices or logical volumes (LVs). The LVs may or may not correspond to the actual physical devices or drives 16a-n. For example, one or more LVs may reside on a single physical drive or multiple drives. Data in a single data storage system, such as a single data storage array 105, may be accessed by multiple hosts allowing the hosts to share the data residing therein. The HA 21 may be used in connection with communications between a data storage array 105 and one or more of the host systems 14a-n. The RA 40 may be used in facilitating communications between two data storage arrays. The DA 30 may be one type of device interface used in connection with facilitating data transfers to/from the associated disk drive(s) 16a-n and LV(s) residing thereon. A flash device interface 35 may be another type of device interface used in connection with facilitating data transfers to/from the associated flash devices and LV(s) residing thereon. It should be noted that an embodiment may use the same or a different device interface for one or more different types of devices than as described herein.

The device interface, such as a DA 30, performs IO operations on a drive 16a-n. In the following description, data residing on an LV may be accessed by the device interface following a data request in connection with IO operations that other directors originate. Data may be accessed by LV in which a single device interface manages data requests in connection with the different one or more LVs that may reside on a drive 16a-n. For example, a device interface may be a DA 30 that accomplishes the foregoing by creating job records for the different LVs associated with a device. These different job records may be associated with the different LVs in a data structure stored and managed by each device interface.

The array 105 can also include a resource manager 110 configured to manage array resources (e.g., processing, memory, and storage resources). In embodiments, the manager 110 can measure a performance metrics of the array 105 at a host side 130 of the SAN 18. Based on the performance metrics, the manager 110 can control access to the array resources as described in greater detail herein.

It should be noted that the resource manager 110 may exist external to the data storage array 105 and may communicate with the data storage array 105 using any one of a variety of communication connections. In other embodiments, the resource manager 110 may exist internal to the data storage array 105 and consume shared resources of the array 105, e.g., share the system's processing resources. In one embodiment, the resource manager 110 may communicate with the data storage array 105 through several different connections including, but not limited to, a serial port, a parallel port, and a network interface card via an Ethernet connection. Using the Ethernet connection, for example, the resource manager 110 may communicate directly with DA 30 and HA 21 within the data storage array 105.

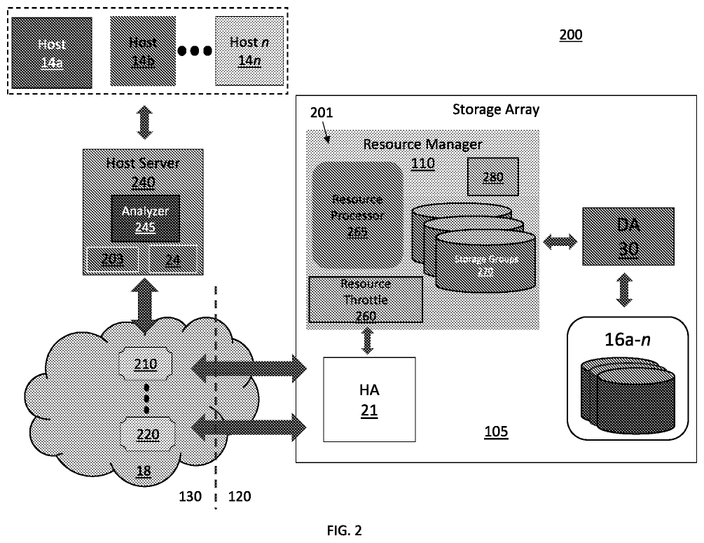

Referring to FIG. 2, a storage system 200 can include a storage array 105 configured to supply data storage services to one or more hosts 14a-n via a SAN 18. In some configurations, the system 200 can have a configuration like system IO of FIG. 1. The system 200 can further include one or more hosts 14a-n that are communicatively coupled to a storage array 105 through a communications network (e.g., the SAN 18). A host server 240 can perform one or more load balancing techniques in response to receiving communications from the SAN directed to the hosts 14a-n.

In embodiments, the hosts 14a-n can include one or more applications (not shown) that perform, e.g., one or more host business operations. In response to operations performed by the applications, the hosts 14 a-n can issue IOs (e.g., read/write data operations) to the array 105. Further, the applications can perform operations having distinct levels of importance for a host business. As such, the data involved with IOs resulting from an application operation can have a corresponding importance level.

Based on each application's importance, the hosts 14a-n can have certain storage array performance requirements for each application's related data. As such, the host business can define a service level objective (SLO) that define certain guaranteed levels of performance requirements corresponding to IOs serviced by the array 105. Further, each of the hosts 14a-n can associate each application to a SLO based on each application's level of importance. A service level agreement (SLA) formed between the host business and a vendor of the array 105 (e.g., Dell Technologies, Inc) can define each SLO. For example, the SLA can be an electronic data structure that defines performance requirements and other provisions that can be in a written legal agreement between two parties. In contrast to a written contract, the SLA data structure is a searchable object that includes rules and instructions that can control and/or configure the array 105. Each SLO can define a guaranteed level of performance with respect to each applicant's corresponded IO operations serviced by the array 105. In embodiments, the SLO can be expressed in terms of one or more metrics, such as a response time (RT). In an example, each SLO can define a range of RTs (Response Times) or an average response time (RT) with respect to IOs issued by each SLO's associated application(s). For example, an SLO may specify an average RT of 3 milliseconds (ms) for an application whereby the application is guaranteed to have an average RT of 3 ms for its IOs serviced by the array 105. In embodiments, the array 105 can establish logical groups (e.g., storage groups (SGs)) of one or more logical unit numbers (LUNs) configured to supply a virtual reference to one or more of the disks 16a-n. Further, the array 105 can assign each SG to one or more of the SLOs.

In other embodiments, an SLA can define an SLO using one or more other metrics other than RT. For example, the SLA can define IO related SLOs in terms of guaranteed IO throughput (e.g., IO rate such as IOs per second (IOPS)), data throughput (e.g., megabytes per second), and the like. In an embodiment, the SLA can define one or more SLOs at a LUN level (e.g., guaranteed for each LUN individually).

In embodiments, the array 105 can perform IO SLO measurements at a host side 130 and/or an array side 120 of the SAN 18. The IO SLO measurements can correspond to IO response time, IOPS, data throughput, and the like. In response to obtaining an IO SLO that does not meet an SLO's performance expectation (e.g., finding an IO SLO violation), the array 105 can perform one or more mitigation techniques such as throttling resources associated with the storage groups 270 and/or LUNs associated with lower priority SLOs (e.g., non-critical SLOs). However, an event unrelated to the array 105 can cause and/or contribute to an SLO violation. For example, the SAN 18, which manages traffic between the hosts 14a-n and the array 105, can experience network congestions resulting from periods of high traffic flows. The network congestion can cause an RT observed by one or more of the hosts 14a-n to be consistent with an SLO violation, while the array 105 can observe an RT that satisfies an expected SLO.

As such, the array 105, in embodiments, can include a resource manager 110 comprising one or more hardware and/or software elements 201. The elements 201 can be configured to identify causes of SLO violations contributing to and/or unrelated to a performance of the array 105. It should be noted that the resource manager 110 and/or any of its elements 201 can be any one of a variety of commercially available processors, such as an Intel-based processor, and the like. Although the elements 201 are shown to exist in the resource manager 110, all or portions of the elements 201 can also exist elsewhere such as, for example, in the HA 21 or DA 30 of FIG. 1. In other embodiments, the resource manager 110 can be a parallel processor such as a graphical processing unit (GPU).

In embodiments, the manager 110 can include a resource processor 265 configured to identify the causes of SLO violations. In an example, the processor 265 can provision a host server 240 with an analyzer 245. For instance, the processor 265 can adapt the host server 240 to include the analyzer 245 via a driver. The driver can adapt a processing element of the host server 240 to analyze IO traffic flows at the host side SAN 130. For example, the analyzer 245 can be configured to measure IO related traffic via one or more communication protocol adapters 201, 202 (e.g., Fibre channel adapters).

In embodiments, the IO traffic flow can include IO communication messages. In examples, the IO communication messages can include one or more of IO requests issued by the hosts 14a-n, array IO receipt acknowledgements, array IO response messages, data involved one or more of the IO requests, and the like. The analyzer 240 can transmit and/or receive time stamps, network path information, and IO related identification metadata, amongst other network communications information. The analyzer 240 can further generate and maintain a log that correlated related IO communication messages and their respective extracted information. For example, the log can be a searchable data structure configured to associate and correlated related data, for example, by matching one or more metadata fields of the IP communication messages.

In embodiments, IO communications can occur over one or more communication paths over the SAN 18. In examples, a SAN communication path can be defined by SAN switches (e.g., Fibre channel switches) 210, 220 that route IO communication messages over the SAN 18. The switches can 210, 220 use routing information (e.g., origin and destination addresses) in the messages to route IOs. Further, the array 105 can include one or more communication ports communicatively coupled to at least one of the SAN switches 210, 220. The array 105 can further assign each SG and/or LUN to at least one of the communication ports. Accordingly, the hosts 14a-n can direct IOs to specific ports of the array 105 based on a port mapping of each array port to one or more SGs, LUNs and/or the SLO associated with each SG and/or LUN.

In embodiments, the analyzer 240 can measure a response time (RT) associated with each IO communication message from, e.g., extracted transmit and/or receive timestamps. In other embodiments, the analyzer 240 can issue a reporting signal including a most recently updated measurements log to the array 105. In turn, the array 105 can measure the RT using the most recently updated measurements log. Using the measurements log, the processor 265 can perform an SLO compliance status check. For example, the processor 265 can match an IO's measured RT to the IO's expected RT defined by its SLO by searching a searchable SLO data structure. The SLO data structure correlate one or more performance requirements (e.g., RTs) with each SLO. Based on a comparison of the one or more performance requirements with measured performances (e.g., IO RTs), the processor 265 can identify an SLO violations (e.g., an IO RT that exceeds an expected RT defined by the SLO).

In embodiments, the processor 265 can further identify one or more causes of an identified SLO violation. In addition, the processor 265 can calculate a congestion level (e.g., throughput and/or latency) of one or more of the SAN communications paths. For example, the processor 265 can calculate the congestion levels based on timestamps of each communication message included in an IO communication flow (e.g., request, acknowledgement, and response messages, amongst other known communication flow messages). Additionally, the processor 265 can identify one or more specific SAN communication paths experiencing a congestion by processing each IO's SLO through the port mapping. Specifically, the port mapping can identify at least one of the SAN switches 210, 220 involved with the IO that experienced an SLO violation.

Based on the measured congestion, the processor 265 can determine an amount a host side SAN 130 and/or an array side SAN 120 contributed to the SLO violation. For instance, the processor 265 can compare an array side SAN RT measurement with the measured congestion to determine the contribution amounts.

In embodiments, the processor 265 can establish and maintain an IO data structure that associates and/or correlates the port mappings with IO SLOs, SGs, and/or LUNs. Accordingly, the processor 265 can identify the SGs and/or LUNs that share a port associated with a congested SAN communication path. As such, the processor 265 an generate SLO mitigation models that limit resource allocation adjustments to those SGs and/or LUNs sharing the same port associated with the congested SAN communication path.

In embodiments, the manager 110 can include a resource throttling processor 260 that can dynamically adjust an amount of storage array resources allocated to each SG and/or LUN using one or more of the SLO mitigation models. The processor 260 can further be configured to analyze performance characteristics of the array 105 and IO RTs resulting from an adjustment of allocated resources. Based on the analysis, the resource throttling processor 260 can provide metrics to tune one or more of the SLO mitigation models.

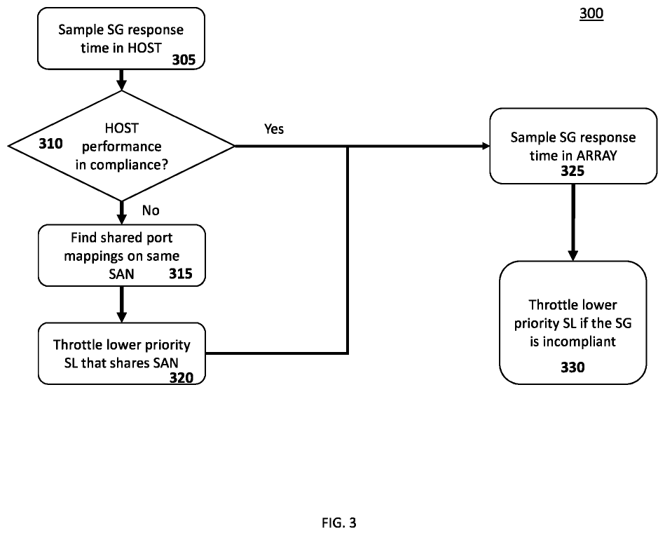

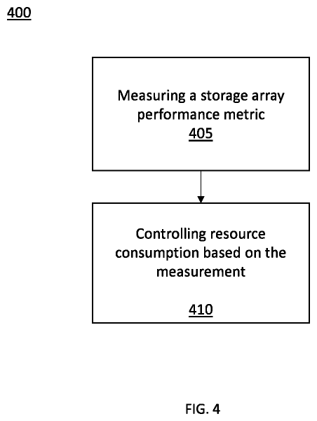

FIGS. 3-4 illustrate methods and/or flow diagrams per this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter.

Referring to FIG. 3, in embodiments, a method 300 can be executed by a resource manager (e.g., the manager 110 of FIG. 1). At 305, the method 300 can include sampling a storage group (SG) response time at a host side of a SAN. The method 300, at 310, can further include determining if the response time is compliant with a host's performance expectation. If the response time is compliant, the method 300 can continue, at 325. If the response time is incompliant, the method 300, at 315, identifies SGs sharing a SAN port with the SG associated with the sampled SG response time. Further, at 320, the method 300 can include throttling those SGs of the identified SGs associated with service level objective (SLO) priorities lower than the sampled SG's priority level. Additionally, the method 300, at 325, can include sampling the SG response time at a storage array side of the SAN. The method 300, at 330, can further include determining if the SG response time at the array side of the SAN is compliant with the host's performance expectation. If the SG response time is incompliant, the method 300, at 330, can include throttling one or more of the SG groups having an SLO priority lower than the sampled SG's SLO priority. In embodiments, the method 300, at 330, can include throttling any SG with a lower SLO priority irrespective of whether a SG shares a SAN port with the sampled SG.

It should be noted that the method 300 can be performed according to any of the embodiments described herein, known to those skilled in the art, and/or yet to be known to those skilled in the art.

Referring to FIG. 4, in embodiments, a method 400 can be executed by a resource manager (e.g., the manager 110 of FIG. 1). At 405, the method 400 can include measuring a storage array performance metric at a host device side of one or more storage area networks (SANs). At 410, the method can include controlling resource consumption of at least one component of the storage array based on the performance metric.

It should be noted that the method 400 can be performed according to any of the embodiments described herein, known to those skilled in the art, and/or yet to be known to those skilled in the art.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the concepts described herein by operating on input data and generating output. Method steps can also be performed by and an apparatus can be implemented as special purpose logic circuitry. The circuitry can, for example, be a FPGA (field programmable gate array) and/or an ASIC (application specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any digital computer. A processor receives instructions and data from a read-only memory or a random-access memory or both. The essential elements of a computer are a processor for executing instructions and one or more memory devices for storing instructions and data. A computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM (electrically programmable ROM (Read Only Memory)), EEPROM (Electrically EPROM), flash memory devices, magnetic disks, internal hard disks, removable disks, magneto-optical disks, CD-ROM (compact disk read only memory), and/or DVD-ROM disks. The processor and the memory can be supplemented by, and/or incorporated in special purpose logic circuitry.

To support interaction with a user, the above described embodiments can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to support interaction with a user. Other devices can, for example, be feedback provided to the user in any form of sensory feedback (e.g., visual feedback, auditory feedback, or tangible feedback). Input from the user can, for example, be received in any form, including acoustic, speech, and/or physical input.

The above described embodiments can be implemented in a distributed computing system that includes a back-end component. The back-end component can, for example, be a data server, a middleware component, and/or an application server. The above described embodiments can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are remote from each other and typically interact through a communication network. The relationship of client and server arises by computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM (Global System for Mobile)) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the concepts described herein may be embodied in other specific forms without departing from the spirit or essential characteristics thereof. The foregoing embodiments are therefore to be considered in all respects illustrative rather than limiting of the concepts described herein. Scope of the concepts is thus indicated by the appended claims, rather than by the foregoing description, and all changes that come within the meaning and range of equivalency of the claims are therefore intended to be embraced therein.

What is claimed is:

1. An apparatus configured to at least one processor configured to:
measure a storage array performance metric at a host device side of one or more storage area networks (SANs); and
control resource consumption of at least one component of the storage array based on the performance metric.

2. The apparatus of claim 1 further configured to:
determine a service level objective (SLO) of each input/output (IO) operation received by a storage array; and
determine all possible SLOs associated with each host organization authorized to communicate with the storage array.

3. The apparatus of claim 1 further configured to identify storage groups associated with each of the SLOs.

4. The apparatus of claim 3 further configured to determine each logical unit number (LUN) device associated with each storage group.

5. The apparatus of claim 4 further configured to identify a communication port assigned to each LUN device.

6. The apparatus of claim 5 further configured to determine a SAN of the one or more SANs over which each communication port is configured to issue communication signals.

7. The apparatus of claim 6 further configured to determine a congestion level of each of the SANs.

8. The apparatus of claim 7 further configured to determine an impact the congestion level of each SAN has on the performance metric.

9. The apparatus of claim 8 further configured to:
adapt a host side SAN load balancing protocol to measure the storage array performance metric; and
determining whether a response time of a message sent to a host device over one of the SANs meets an SLO expected by the host device using measurements received from the adapted host side SAN load balancing protocol.

10. The apparatus of claim 9 further configured to:
determine which storage group is a source of the message;
identify the SAN associated with the storage group; and
throttle messages corresponding to low priority SLOs that share the identified SAN.

11. A method comprising:
measuring a storage array performance metric at a host device side of one or more storage area networks (SANs); and
controlling resource consumption of at least one component of the storage array based on the performance metric.

12. The method of claim 11 further comprising:
determining a service level objective (SLO) of each input/output (IO) operation received by a storage array; and
determining all possible SLOs associated with each host organization authorized to communicate with the storage array.

13. The method of claim 11 further comprising determining storage groups associated with each of the SLOs.

14. The method of claim 13 further comprising determining each logical unit number (LUN) device associated with each storage group.

15. The method of claim 14 further comprising identifying a communication port assigned to each LUN device.

16. The method of claim 15 further comprising determining a SAN of the one or more SANs over which each communication port is comprising issue communication signals.

17. The method of claim 16 further comprising determining a congestion level of each of the SANs.

18. The method of claim 17 further comprising determining an impact the congestion level of each SAN has on the performance metric.

19. The method of claim 18 further comprising:
adapting a host side SAN load balancing protocol to measure the storage array performance metric; and
determining whether a response time of a message sent to a host device over one of the SANs meets an SLO expected by the host device using measurements received from the adapted host side SAN load balancing protocol.

20. The method of claim 19 further comprising:
determining which storage group is a source of the message;
identifying the SAN associated with the storage group; and
throttling messages corresponding to low priority SLOs that share the identified SAN.
